(19) United States
(12) Patent Application Publication
(10) Pub. No.: US 2004/0214010 A1
(43) Pub. Date: Oct. 28, 2004

(54) Glass for use in freezers/refrigerator and glass article using said glass

(76) Inventors: Kenji Murata, Tokyo (JP); Hidemi Nakai, Ibaraki (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/168,813

(22) PCT Filed: Dec. 20, 2000
(86) PCT No.: PCT/JP00/09043

(30) Foreign Application Priority Data
Dec. 28, 1999 (JP) 11374150

(51) Int. Cl. B32B 17/06

(52) U.S. Cl. 428/426

(57) ABSTRACT

The present invention relates to a glass for freezers and refrigerators and a glass article formed of the glass, and its technical problem to be solved is to secure a sufficient thermal insulating ability, reduce the cost, prevents dew condensation without consuming extra power energy as well as secure desired transparency. In the glass for freezers and refrigerators, a tin oxide film and a silicon oxide film are laminated on a surface of the glass substrate in this order, and a tin oxide film with fluorine added (low-radiation layer) is formed on the silicon oxide film. The glass is installed in a freezer or refrigerator such that a surface of the glass formed with the low-radiation layer faces onto the inside of the freezer or refrigerator. A glass article in which is used one or more sheets of the above glass, such as a multi-layered glass, with improved thermal insulation can be obtained.

### BACKGROUND OF THE INVENTION

1. Technical Field

The present invention relates to a glass for freezers and refrigerators and a glass article formed of the glass, and more specifically to a glass for freezers and refrigerators used in a freezer or refrigerator as a glass window that maintains thermal insulation and is transparent so as to make the state of the inside of the freezer or refrigerator visible from the outside, and a glass article such as a multi-layered glass in which is used one or more sheets of the above glass, thus improving the thermal insulation ability as a glass window.

2. Background Art

Freezers and refrigerators used in shops such as supermarkets and convenience stores are required to have a product display function of displaying products and a product selection function of allowing consumers to freely pick out products. Glass windows that are equipped with an opening/closing mechanism and both maintain thermal insulation and ensure transparency are thus used in such freezers and refrigerators. Moreover, glass windows that both maintain thermal insulation and ensure transparency have similarly been proposed for use in freezing/refrigerating that allow product purchasers to visually identify products easily and shopkeepers to put in and take out products easily, and so-called see-through type vending machines that allow consumers to determine the state of availability of products instantaneously.

Among glass windows used in freezers and refrigerators whose internal temperature must be held at a predetermined value, there are known those which are composed of multi-layered glass having improved thermal insulation ability as a glass window so as to reduce the energy consumed for maintaining the internal temperature as much as possible. Known multi-layered glasses of this kind include a multi-layered glass which is comprised of a plurality of glasses arranged in facing relation to one another with a hollow layer interposed between them, and a multi-layered glass in which plastic films are stuck to surfaces of the above plurality of glasses facing one another. Also known are a multi-layered glass in which low-radiation layers are formed on surfaces of the glasses facing the above hollow layer and a multi-layered glass in which low-radiation layers are formed on the surfaces of the glasses facing the hollow layer. Still further known is a multi-layered glass in which a heat-insulating gas such as argon or krypton gas is supplied into the hollow layer to improve the thermal insulation ability (these multi-layered glasses will hereinafter referred to as “the first prior art”).

According to the first prior art, due to the adiabatic effect of the glass, the thermal insulation ability of the glass window is increased. Consequently, the temperature of the surface of the glass facing the outside of the freezer or refrigerator becomes closer to the ambient temperature of the freezer or refrigerator so that dew condensation is unlikely to occur on the surface of the glass facing the outside of the freezer or refrigerator, whereby the transparency of the glass window is not spoiled and the floor surface on which the freezer or refrigerator is placed is prevented from becoming slippery due to condensation dew drop from the freezer or refrigerator.

According to the first prior art, however, for example, when products are taken out of the freezer or refrigerator or put into the same, the atmospheric air easily enters the freezer or refrigerator. When the atmospheric air contacts the surface of the glass window facing the inside in entering the freezer or refrigerator, dew condensation easily occurs on the surface, or condensation dew on the surface facing the inside enters the freezer or refrigerator and can become frozen.

Further, the above-mentioned multi-layered glasses include a type in which a resin film having a transparent electric conductive coating is applied to a surface of a glass plate on the outside of the freezer or refrigerator, which faces onto the hollow layer to serve as a transparent heater, and a type in which a transparent electric conductive coating is directly applied on the surface of the glass plate, and in these types, the transparent electric conductive coating (transparent heater) is energized with electricity to be heated, thereby increasing the surface temperature of the glass plate on the outside of the freezer or refrigerator and hence making dew condensation unlikely to occur on the outside surface of the freezer or refrigerator (these types will be hereinafter referred to as the second prior art”).

According to the second prior art, the energization of the transparent electric conductive coating (transparent heater) can increase the surface temperature of the glass plate on the outside of the freezer or refrigerator, and can therefore effectively prevent dew condensation on the outside surface of the freezer or refrigerator.

According to the second prior art, however, the transparent electric conductive coating is electrically conductive and hence has low emissivity. As a result, heat can be transmitted only via heat conduction to the inside of the freezer or refrigerator, whereby actually the glass surface on the inside of the freezer or refrigerator cannot be easily warmed up and the rate of increase in the temperature of the glass surface on the inside is very low. Besides, on one hand, energy is, consumed for energizing the transparent electric conductive coating for heating, and on the other hand, energy is also consumed for cooling the inside of the freezer or refrigerator. Thus, the energy efficiency of the whole freezer or refrigerator is very low from the standpoint of energy economy.

Moreover, as another prior art, there is known a glass window in which a plastic film with a low-radiation layer formed thereon is applied on the surface of the glass plate on the inside of the freezer or refrigerator (hereinafer referred to as “the third prior art”).

According to the third prior art, the low-radiation film formed on the plastic film serves to enhance the thermal insulating ability and increase the surface temperature of the glass window on the inside of the freezer or refrigerator, whereby, even if ambient temperature enters the freezer or refrigerator and contacts the surface of the glass on the inside of the freezer or refrigerator, dew condensation is unlikely to occur on the surface.

According to the third prior art, however, the above plastic film is generally low in hardness, and therefore the plastic film having the low-radiation layer can be damaged during cleaning or during putting or taking products into or out of the freezer or refrigerator. That is, since the plastic film can be thus easily damaged, care must be taken so as not to keep products from contacting the plastic film during putting or taking products into or out of the freezer or refrigerator, and cleaning must be made by softly wiping dust off using a soft cloth. Thus, the freezer or refrigerator is not easy to handle. Besides, it is actually almost impossible to make product purchasers take care so as not to touch the surface of the glass on the inside of the freezer or refrigerator, and as a result, the freezer or refrigerator will lose its good appearance and its transparency after a short time of use.

In addition, according to the third prior art, the plastic film with the low-radiation layer formed thereon itself is expensive, and besides, it takes much time to apply the plastic film onto the surface of the glass plate, and an exclusive special device is required to finish application of the plastic film so as to obtain the good appearance.

The present invention has been made in view of the above-mentioned problems, and it is an object of the present invention to provide a glass for freezers and refrigerators which is capable of securing a sufficient thermal insulating ability, low in cost, and capable of preventing dew condensation without consuming extra power energy as well as preventing spoilage of the transparency, and a glass article formed of the glass.

### DISCLOSURE OF THE INVENTION

The present inventors carried out assiduous studies in order to obtain a glass for freezers and refrigerators which is capable of securing a sufficient thermal insulating ability and is free from dew condensation, for example, during taking products out of the freezer or refrigerator, and as a result discovered that, if a low-radiation layer is formed as a film on a surface of a glass plate facing the inside of the freezer or refrigerator, a sufficient thermal insulating ability of the glass window can be secured, and moreover the surface temperature of the glass plate facing the inside of the freezer or refrigerator can be increased, and as a result, dew condensation is unlikely to occur and spoilage of the transparency can be avoided.

More specifically, it has been turned out that by forming a low-radiation layer as a film on a surface of a glass plate facing the inside of the freezer or refrigerator, the emissivity for radiant heat between the space inside of the freezer or refrigerator and the surface of the glass facing the inside of the freezer or refrigerator is reduced and hence radiative heat transfer is suppressed, and convective heat transfer becomes predominant. As a result, not only is the thermal insulation ability of the glass window improved, but also the surface temperature of the surface of the glass facing the inside of the freezer or refrigerator is raised, and hence even when air from the outside of the freezer or refrigerator gets into the inside of the freezer or refrigerator when products are being taken out of the freezer or refrigerator or the freezer or refrigerator is being replenished with products and this air comes into contact with the surface of the glass facing the inside of the freezer or refrigerator, condensation is not prone to occur on the surface of the glass facing the inside of the freezer or refrigerator, and even if such condesation occurs, the glass will recover visibility in a short period of time.

The low-radiation layer is not only always exposed to the low-temperature atmosphere inside the freezer or refrigerator-but also rather there is an abrupt temperature change due to room-temperature air from outside the freezer or refrigerator getting into the freezer or refrigerator. Moreover, there is a possibility of wear of the low-radiation layer due to being rubbed during cleaning of the inside of the freezer or refrigerator or contact of products or product purchasers with the low-radiation layer due to the products being put in or taken out or carelessness of the product purchasers. The low-radiation layer thus needs to have excellent physical and chemical durability. From this point of view, the optimum material for the low-radiation layer is an oxide semiconductor film.

Therefore, the glass for freezers and refrigerators according to the present invention is characterized by a glass, which partitions a first space at room temperature from a second space at a temperature below room temperature, wherein the glass comprises a glass plate having a low-radiation layer comprising an oxide semiconductor film formed on a surface of the glass plate facing the second space (inside of the freezer or refrigerator).

According to the above construction, since a glass plate having a low-radiation layer comprising an oxide semiconductor film is formed on a surface of the glass plate facing the second space, the emissivity for radiant heat becomes low enough to secure an excellent thermal insulating ability. Further, the radiative heat transfer is suppressed so that the surface temperature of the low-radiation layer becomes closer to the surface temperature of the glass plate on the outside of the freezer or refrigerator, whereby the surface temperature of the low-radiation layer rises and hence dew condensation is prevented from occurring to thereby avoid spoilage of the transparency.

Further, according to the above construction, since the surface temperature of the low-radiation layer rises, the difference between the temperature within the second space (inside the freezer or refrigerator) and the surface temperature of the low-radiation layer) becomes large and hence convective heat transfer becomes more prone to occur, and thus exchange of air at the surface of the low-radiation layer becomes more prone to occur, and hence even if condensation does occur temporarily, the condensation can be eliminated in a short time.

Thus, according to the glass for freezers and refrigerators of the present invention, the surface temperature of the glass on the outside of the freezer or refrigerator can be maintained high while securing a sufficient thermal insulating ability of the glass window, which makes dew condensation that degrades the transparency unlikely to occur.

Moreover, the glass for freezers and refrigerators according to the present invention does not use any special electric power such as a heater as used in the prior art, and the oxide semiconductor film as the low-radiation layer has excellent physical and chemical durability and is not easily damaged unlike a plastic film, and permits easy cleaning or the like, and ease of use can be improved at low cost.

The oxide semiconductor film forming the low-radiation layer preferably comprises a tin oxide film (hereinafter referred to as “SnO₂:F”) containing fluorine that can be easily produced by chemical vapor deposition (hereinafter referred to as “CVD”) during a float glass manufacturing process, is suited to mass production, and can be manufactured inexpensively.

Moreover, since products are frequently takes out of and put into freezers and refrigerators, the reflected color tone of the glass for freezers and refrigerators should be desirably an achromatic color system that gives a natural color tone, i.e. a neutral system. The formation of only the oxide semiconductor film on the surface of the glass plate still makes it difficult to adjust the reflected color tone to such an achromatic color system. Therefore, it is preferable to interpose inorganic materials which do not impair the physical durability of the low-radiation layer between the low-radiation layer and the glass plate, and hence this intermediate layer acts as a refractive index adjusting layer, to thereby enable adjustment of the reflected color tone.

Thus, the glass for freezers and refrigerators according to the present invention preferably contains an intermediate layer comprising inorganic materials interposed between the glass plate and the low-radiation layer.

According to the above construction, the intermediate layer interposed between the glass plate and the low-radiation layer enables a high transparency with a neutral reflected color tone to be maintained even when the glass for freezers and refrigerators is used in a freezing/refrigerating showcase or a see-through type vending machine.

Further, to improve the strength of the glass or to carry out bending processing, the glass for freezers and refrigerators may be subjected to predetermined heat treatment, and moreover such heat treatment may be necessary if coating the glass with a hydrophilic or photocatalytically active substance or carrying out antibacterial treatment. If such heat treatment is carried out after the low-radiation layer has been formed, then the manufacturing process as a whole can be carried out inexpensively and quickly, and moreover the properties of the oxide semiconductor film that makes up the low-radiation layer are not degraded by the heat treatment.

Thus, predetermined heat treatment at a predetermined temperature may be carried out on the glass for freezers and refrigerators of the present invention after the low-radiation layer has been formed.

The present inventors further made assiduous studies and reached the finding that, if a surface layer having a hydrophilic/moisture-retaining function is formed on the surface of the low-radiation layer in the glass for freezers and refrigerators of the present invention, then the contact angle of any water droplets that become attached to the glass can be reduced, and hence even if moisture condenses onto the surface layer, the glass will not be prone to condensation, and thus the transparency will tend not to be impaired, and that from the viewpoint of maintaining high chemical and physical durability, the surface layer should preferably comprise a composite oxide or mixed oxide containing at least one element selected from the group consisting of silicon, aluminum and titanium.

Thus, preferably a surface layer comprising a composite oxide or mixed oxide containing at least one element selected from the group consisting of silicon, aluminum and titanium is further formed on the surface of the low-radiation layer in the glass for freezers and refrigerators of the present invention

According to the above construction, even if moisture condenses onto the surface layer, it can be avoided that the glass undergoes condensation to have its transparency impared. In particular, if the surface layer contains a photocatalytically active substance, organic soiling on the surface of the glass will be decomposed, and hence the hydrophilic/moisture-retaining function can be maintained over a long time.

Moreover, so that the low emissivity, i.e. the high infrared-reflecting performance, of the low-radiation layer is not impaired, the surface layer is preferably as thin as possible, insofar as the desired hydrophilic/moisture-retaining function thereof is secured. Specifically, the thickness of the surface layer is preferably in a range of 0.5 to 1000 nm, most preferably 1 to 300 nm.

Furthermore, it is common for the inside of a freezer or refrigerator to be illuminated with lighting equipment such as fluorescent lighting, and hence it is preferable for the surface layer to contain a photocatalytically active substance. As a result, organic soiling on the surface of the glass will be decomposed, and hence the hydrophilic/moisture-retaining function can be maintained over a long time.

Moreover, when a freezer or refrigerator in which the glass for freezers and refrigerators of the present invention is installed is used for storing and displaying foods, from the viewpoint of hygiene it is preferable for antibacterial treatment to be carried out on at least one of the surface of the glass on the inside of the freezer or refrigerator and the surface of the glass on the outside of the freezer or refrigerator. Note that in the case of silver-type treatment, which is commonly carried out as such antibacterial treatment, the antibacterial property tends not to be produced at a low temperature, and hence the glass of the present invention, for which the surface of the glass on the inside of the freezer or refrigerator can be maintained at a high temperature, is suited to such antibacterial treatment.

Further, in order to visually identify products in the freezer or refrigerator from outside the freezer or refrigerator under a room temperature atmosphere, it is preferable for the visible light transmittance of the glass to be not less than 60%, more preferably not less than 80%, and hence the material for the glass plate should be selected from materials having a visible light transmittance within the above range.

Furthermore, the glass for freezers and refrigerators should not only maintain high transparency as a glass window but also maintain the radiant heat exchange between the inside of the freezer or refrigerator and the surface of the low-radiation layer as low as possible to thereby reduce the emissivity for radiant heat. To this end, the normal emittance of the low-radiation layer is preferably not more than 0.35, more preferably not more than 0.25, and yet more preferably not more than 0.15.

When the glass for freezers and refrigerators of the present invention is installed in a freezer or refrigerator such that one looks up into the freezer or refrigerator from below, the convective heat transfer effect is greater, and hence the effects of the present invention are reduced, compared with when the glass for freezers and refrigerators of the present invention is installed vertically. Conversely, when the glass for freezers and refrigerators is installed within a predetermined angle of inclination range relative to the horizontal direction such that one can look into the freezer or refrigerator diagonally from above or directly from above, not only radiative heat transfer but also convective heat transfer between the inside of the freezer or refrigerator and the surface of the low-radiation layer becomes not prone to occur, and hence the surface temperature of the low-radiation layer rises further, and thus clouding up of the glass plate can be prevented yet more effectively.

The glass for freezers and refrigerators of the present invention is thus preferably installed in the freezer or refrigerator main body such that the angle of inclination relative to a state in which the surfaces of the glass are horizontal and the low-radiation layer is on the underside of the glass in the vertical direction is in a range of 0 to 135°, more preferably 0 to 60°.

Moreover, it has been known since hitherto that a multi-layered glass (a glass article) in which at least one hollow layer such as an air layer, a thermally insulating gas layer or a reduced pressure layer is interposed between a plurality of substrates of glass exhibits an effect of an extremely good thermal insulation performance. In the case that the glass for freezers and refrigerators of the present invention is incorporated into such a multi-layered glass, however, the thermal insulation performance can be further improved, while preventing the occurrence of condensation.

In such a glass article according to the present invention, a plurality of sheets of glass including at least one sheet of a glass for freezers and refrigerators according to the present invention as described above are arranged in facing relation to one another such that the low-radiation layer side of the glass for freezers and refrigerators faces the space at a temperature below room temperature, and at least one hollow layer is formed between the plurality of sheets of glass; the hollow layer is one of an air layer, a thermally insulating gas layer and a reduced pressure layer.

It should be noted that when manufacturing such a glass article containing a reduced pressure layer, it is preferable to carry out degassing treatment in which heating to 150° C. or above is carried out, so that the reduced pressure state in the reduced pressure layer will be maintained for a long time; the properties of the oxide semiconductor film that makes up the low-radiation layer will not be degraded during such degassing treatment, which is desirable.

Furthermore, in the glass article according to the present invention, preferably, a low-radiation layer or a transparent film containing a low-radiation substance is formed on a surface facing the hollow layer of at least one sheet of glass out of the plurality of sheets of glass that face one another. Preferably, the low-radiation layer or transparent film containing a low-radiation substance is disposed in the hollow layer away from surfaces of the glass according to the present invention. As a result, the thermal insulation ability can be improved yet further.

Alternatively, it is also preferable to make the glass article of the present invention be a laminated glass in which a plurality of sheets of glass including at least one sheet of a glass for freezers and refrigerators as described above are superimposed via at least one transparent resin layer, such that the low-radiation layer side of the glass for freezers and refrigerators faces the space at a temperature below room temperature.

Furthermore, it is also preferable to select two sheets of multi-layered glass out of the multi-layered glasses described above and form a glass article by superimposing these two sheets of multi-layered glass via a transparent resin layer.

Moreover, as with the glass for freezers and refrigerators, it is preferable to carry out antibacterial treatment on the glass articles (multi-layered glass, laminated glass) described above from the viewpoint of hygiene.

### BRIEF DESCRIPTION OF THE DRAWINGS

FIG. 1 is a schematic sectional view of a glass for freezers and refrigerators according to an embodiment of the present invention;

FIG. 2 is views showing examples of the state of installation of the glass for freezers and refrigerators of the present invention in a freezer or refrigerator main body;

FIG. 3 is a schematic view showing the constitution of a CVD film-forming apparatus;

FIG. 4 is a schematic sectional view of a glass for freezers and refrigerators according to a second embodiment of the present invention;

FIG. 5 is a schematic view showing the constitution of a sputtering apparatus;

FIG. 6 is a schematic sectional view of a glass article according to a first embodiment of the present invention;

FIG. 7 is a schematic sectional view of a glass article according to a second embodiment of the present invention; and

FIG. 8 is a schematic sectional view of a glass article according to a third embodiment of the present invention.

### BEST MODE OF CARRYING OUT THE INVENTION

Embodiments of the present invention will now be described in detail with reference to the drawings.

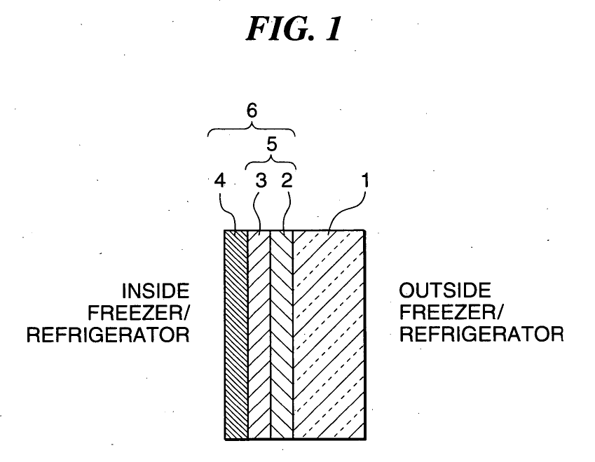

FIG. 1 is a schematic sectional view of a glass for freezers and refrigerators according to a first embodiment of the present invention.

In FIG. 1, reference numeral 1 designates a glass substrate that has a soda-lime glass as a principal component thereof and is manufactured through a float process. A tin oxide film (hereinafter referred to as “SnO₂ film”) 2 is formed on a surface of the glass substrate 1, and a silicon oxide film (hereinafter referred to as “SiO₂ film”) 3 is formed on the surface of the SnO₂ film 2. Further, an SnO₂ film 4 as a low-radiation layer is formed on the surface of the SiO₂ film 3. The SnO₂ film 2 and the SiO₂ film 3 together make up an intermediate layer 5. The intermediate layer 5 and the SnO₂: F film 4 together make up a film laminate 6.

In the present embodiment, the glass is installed as a glass window in a freezer or refrigerator in a supermarket, a convenience store or the like, in such a way that the surface of the glass substrate 1 on which no films are formed faces onto the outside of the freezer or refrigerator (first space), which is at room temperature, and the surface on which the SnO₂: F film 4 is formed faces onto the inside of the freezer or refrigerator (second space), which is at a temperature below room temperature.

When the glass for freezers and refrigerators as described above is used installed in a freezer or refrigerator in a supermarket, convenience store or the like, because products will be frequently put into and taken out of the freezer or refrigerator, it is necessary for it to be easy to visually identify products in the freezer or refrigerator from outside the freezer or refrigerator. It is thus preferable for the visible light transmittance of the glass to be not less than 60%, preferably 70%, more preferably not less than 80%, and hence the composition of the glass substrate 1 is selected such that the glass substrate 1 has a visible light transmittance of not less than 60%.

The thicknesses of the various films in the film laminate 6 are adjusted as follows.

(1) Thickness of SnO₂:F film 4

The SnO2:F film 4 is a thin film of tin oxide with fluorine doped therein. The electrical conductivity of the thin film is raised by doping the tin oxide with the fluorine. As a result, light in the infrared region (wavelength 5.5 to 50 μm) is reflected effectively, and hence the thermal insulation performance is improved. Moreover, heat transfer with the inside of the freezer or refrigerator in which the glass is installed occurs through radiative heat transfer and convective heat transfer. The SnO₂:F film 4 has an action of reducing the emissivity for radiant heat and hence suppressing radiative heat transfer (i.e. low-radiation performance); as a result, the temperature of the surface of the glass on the inside of the freezer or refrigerator rises and hence condensation is prevented. The low-radiation performance can be evaluated through the normal emittance (JIS R3106), and to secure the desired low-radiation performance it is preferable for the normal emittance to be not more than 0.35, preferably, not more than 0.25, and more preferably not more than 0.15. In the present embodiment, to obtain such a normal emittance, the thickness of the SnO₂:F film 4 must be set to at least 100 nm. However, although the thicker the SnO₂:F film 4 the lower the emissivity can be made, due to production equipment cost constraints it is preferable for the thickness of the SnO₂:F film 4 to be set to not more than 1000 nm, more preferably not more than 500 nm.

(2) Thicknesses of SnO₂ film 2 and SiO₂ film 3

In terms of external appearance, it is preferable for the glass for freezers and refrigerators to not only have a high visible light transmittance but also to be a neutral system giving a natural reflected color tone. Specifically, the reflected color tone of a body such as a glass window can be expressed quantitatively on a chromaticity diagram through the chromaticness indices a* and b* of the L* a* b* color system stipulated by the International Commission on Illumination (Commission Internationale de l'Eclairage—CIE) (JIS Z8729). To obtain a neutral reflected color tone, it is preferable for the chromaticness indices a* and b* to be such that |a*|≦10 and |b*|≦10, more preferably |a*|≦5 and |b*|≦5.

However, there are limitations on how much the reflected color tone can be adjusted using only the SnO₂:F film 4, and there is a risk of iridescent reflected colors being produced through light interference.

In the present embodiment, the SnO₂ film 2 and the SiO₂ film 3 as inorganic materials that do not impair the physical durability of the SnO₂:F film 4 are thus interposed between the glass substrate 1 and the SnO₂:F film 4, thus carrying out adjustment such that the reflected color tone becomes a neutral system. That is, if the SnO₂ film 2 and the SiO₂ film 3 are interposed between the glass substrate 1 and the SnO₂:F film 4, then the SnO₂ film 2 and the SiO₂ film 3 act as refractive index adjusting layers, and as a result the reflected color tone of the glass for freezers and refrigerators can easily be adjusted to be a neutral system.

It should be noted that, although in the present embodiment the intermediate layer 5 is made to be a two-layer structure comprised of the SnO₂ film 2 and the SiO₂ film 3, the intermediate layer 5 is interposed between the glass substrate 1 and the SnO₂:F film 4 with an objective of carrying out color tone adjustment as described above, and hence as long as this color tone adjustment is possible, the intermediate layer 5 is not limited to having the above two-layer structure. Rather, so long as the low-radiation performance is not impaired, the intermediate layer 5 may have a single-layer structure or a multi-layer structure having three or more layers, or may be a graduated composition layer in which the concentration of a particular film component (for example Si or Sn) is made to vary through the film in a graduated fashion.

Moreover, as described above, in the present embodiment the SnO₂:F film 4, which is a low-radiation layer, is formed on the side of the glass substrate 1 facing the inside of the freezer or refrigerator, and hence the emissivity for radiant heat between the space inside the freezer or refrigerator and the surface of the glass inside the freezer or refrigerator becomes low, and thus radiative heat transfer is suppressed, and hence convective heat transfer becomes dominant. As a result, not only does the thermal insulation ability of the glass window improve, but also the surface temperature of the glass on the side inside the freezer or refrigerator increases. Condensation is thus not prone to occur even when air outside the freezer or refrigerator gets into the freezer or refrigerator while products are being put into or taken out of the freezer or refrigerator and this air comes into contact with the surface of the glass on the inside of the freezer or refrigerator, and moreover even if such condensation does occur, the transparency can be recovered within a short time.

The SnO₂: F film 4 constituting the low-radiation layer has excellent physical and chemical durability, and is therefore excellent in durability, and cleaning of the film 4 can be easily carried out.

In the present embodiment, because radiative heat transfer is suppressed, the surface temperature of the low-radiation layer approaches the surface temperature of the glass plate 1 on the side outside the freezer or refrigerator, i.e. the surface temperature of the low-radiation layer rises. Condensation is thus also prevented due to this, and hence impairment of the transparency can be avoided.

Moreover, because the surface temperature of the SnO₂: F film 4 rises, the difference between the temperature of the space inside the freezer or refrigerator and the surface temperature of the low-radiation layer becomes large, and hence convective heat transfer becomes more prone to occur, and thus exchange of air at the surface of the low-radiation layer becomes more prone to occur. Even if condensation does occur temporarily, this condensation can thus be eliminated in a short time.

Furthermore, according to the present embodiment, the increase in the surface temperature of the glass on the side inside the freezer or refrigerator occurs due to the influence of the temperature of the atmosphere outside the freezer or refrigerator. A heater or the like which would require electrical power thus need not be used, which is economical and contributes to energy saving.

When the glass for freezers and refrigerators of the present invention is used as a glass window for a showcase for displaying ice cream or the like, it is preferable for the glass itself to be provided with an opening/closing mechanism when the glass is installed in the showcase. Alternatively, when the glass is fitted into a window frame, it is also preferable for the window frame to be provided with an opening/closing mechanism such as a double sliding mechanism, a single sliding mechanism or an opening mechanism, and to install the glass in the showcase such as to allow opening and closing to be carried out freely.

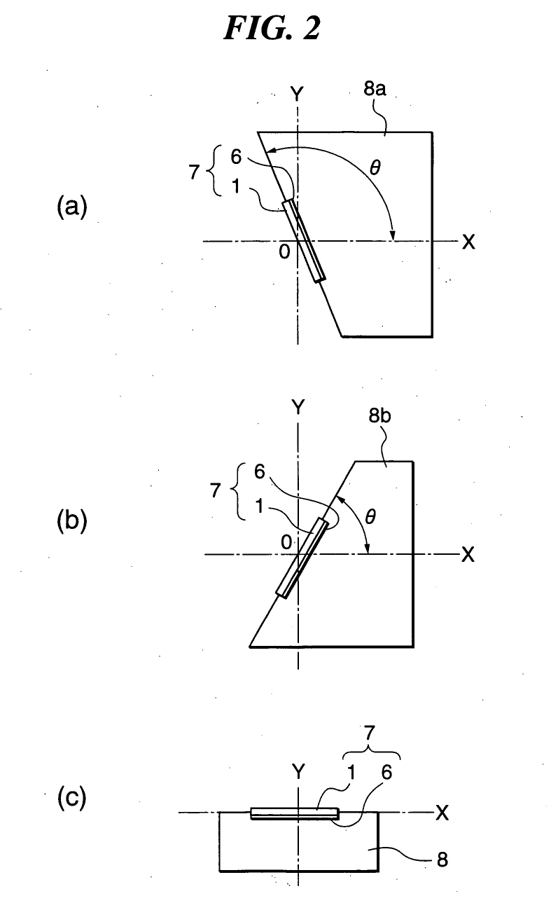

FIG. 2 is views showing examples of modes of installation when the glass for freezers and refrigerators is installed in a freezer or refrigerator main body 8. In the figures, the X-axis indicates the horizontal direction and the Y-axis indicates the vertical direction.

In a standard mode of installation, the glass 7 is horizontal and the film laminate 6 in which is formed the low-radiation layer 4 faces downwards. The glass 7 is installed in the freezer/refrigerator main body 8 such that the low-radiation layer 6 faces onto the inside of the freezer or refrigeration at an angle of inclination θ.

For example, as shown in (a) of FIG. 2, the glass 7 may be installed in a freezer/refrigerator main body 8a in an inclined fashion such that one looks up into the freezer or refrigerator from the outside. In this case, the angle of inclination θ is preferably 0 to 135°. In another example of mode of installation, the glass 7 may be installed in a freezer/refrigerator main body 8b such that one looks down into the freezer or refrigerator from the outside, as shown in (b) of FIG. 2. In this case, the angle of inclination θ is preferably 0 to 60°. In the best mode of installation, the glass 7 is installed at an angle of inclination of 0° such that the glass 7 is horizontally disposed, as shown in (c) of FIG. 2.

In this connection, when the glass 7 of the present invention is installed into the freezer/refrigerator main body 8 such that one looks into the freezer or refrigerator diagonally from above as in FIG. 2B or directly from above as in (c) of FIG. 2, not only radiative heat transfer but also convective heat transfer between the SnO₂: F film 4 (low-radiation layer) and the space inside the freezer or refrigerator occurs with difficulty, and hence the surface temperature of the SnO₂: F film approaches the temperature of the room-temperature atmosphere outside the freezer or refrigerator. Consequently, the surface temperature of the SnO₂: F film 4 thus becomes high, and hence the occurrence of condensation can be prevented more effectively.

A method of manufacturing the glass for freezers and refrigerators of the present invention will now be described.

Possible methods of forming the film laminate 6 onto the glass substrate 1 and thus manufacturing the glass for freezers and refrigerators include a vacuum deposition method, a sputtering method and a spreading application method. However, it is most preferable to carry out the manufacturing using a CVD method, which allows film formation to be carried out easily as part of the float glass manufacturing process, is suited to mass production, and is inexpensive.

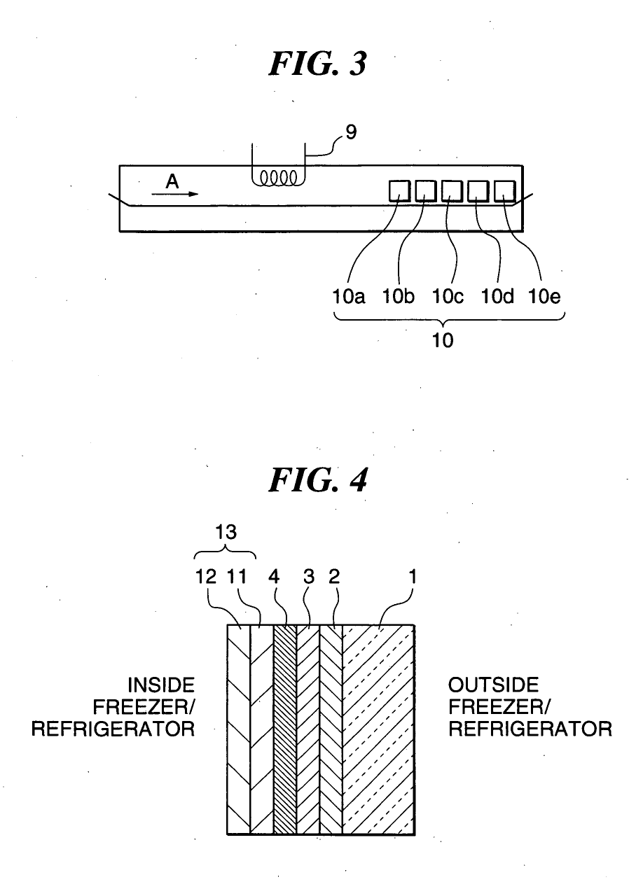

FIG. 3 is a schematic view showing the constitution of a CVD film-forming apparatus. The CVD film-forming apparatus has a heater 9 that heats the glass substrate 1 to a predetermined temperature, and a plurality of film-forming raw material supply parts 10 (in the present embodiment first to fifth film-forming raw material supply parts 10a to 10e) that are provided in a row and each cover the whole width of the glass substrate 1, which is conveyed in the direction of arrow A in FIG. 3.

In the CVD film-forming apparatus, the glass substrate 1, which has been cut into a predetermined shape, is heated to a predetermined temperature by the heater 9, and is conveyed along a mesh belt. While the glass substrate 1 is passing through the apparatus, film-forming raw materials are fed onto the surface of the glass substrate 1, and the film-forming raw materials are thermally decomposed on the glass substrate 1 through the heat energy possessed by the glass substrate 1, thus building up desired thin films on the glass substrate 1. For example, in the case of forming the film laminate 6 shown in FIG. 1, a mixed gas comprised of a tin compound, oxygen, water vapor and nitrogen is first fed onto the surface of the glass substrate 1 from the first film-forming raw material supply part 10a, thus forming the SnO₂ film 2 as a first layer. A mixed gas comprised of a silicon compound, oxygen and nitrogen is then fed onto the glass substrate 1 from the second film-forming raw material supply part 10b, thus forming the SiO₂ film 3 as a second layer. A mixed gas comprised of a tin compound, oxygen, water vapor, nitrogen and a fluorine compound is then fed onto the glass substrate 1 from the third film-forming raw material supply part 10c, and if necessary the fourth and fifth film-forming raw material supply parts 10d and 10e, thus forming the SnO₂: F film 4 as a third layer. That is, when forming a thick film, the same film-forming raw materials may if necessary be fed onto the glass substrate 1 through a plurality of stages (for example, the 3 stages consisting of the third to fifth film-forming raw material supply parts 10c to 10e as described above).

A tin compound such as monobutyltin trichloride, tin tetrachloride, dimethyltin dichloride, dibutyltin dichloride, dioctyltin dichloride, tetramethyltin, tetrabutyltin or tetraoctyltin can be used as the tin raw material for forming the SnO₂ film 2; oxygen, water vapor, dry air or the like can be used as oxidizing raw materials.

A silane compound such as monosilane, disilane, trisilane, monochlorosilane, dichlorosilane, 1,2-dimethylsilane, 1,1,2-trimethyldisilane or 1,1,2,2-tetramethyldisilane, or tetramethyl orthosilicate, tetraethyl orthosilicate or the like can be used as the silicon raw material for forming the SiO₂ film 3; oxygen, water vapor, dry air, carbon dioxide, carbon monoxide, nitrogen dioxide, ozone or the like can be used as oxidizing raw materials.

A trifluoroacetate, hydrogen fluoride, bromotrifluoromethane, chlorodifluoromethane, difluoroethane or the like can be used as the fluorine compound for forming the SnO₂: F film 4.

As described above, the CVD film-forming apparatus in the present embodiment allows film formation to be carried out easily during the float glass manufacturing process, and allows mass production at low cost.

Moreover, the SnO₂: F film 4 is not easily altered by heat treatment, and hence strengthening treatment, bending processing, degassing treatment and the like can be carried out after the SnO₂:F film 4 has been formed, thus allowing the manufacturing process as a whole to be simplified and to be carried out quickly and at low cost.

For example, in the case that the strength of the glass is increased by passing the glass through a thermal strengthening furnace or the like by carrying out this heat treatment after forming the SnO₂: F film 4 (low-radiation layer), the strengthening can be carried out at low cost and quickly, and without bringing about a deterioration in the properties of the SnO₂: F film 4.

That is, strengthened glass can in general be obtained using a thermal strengthening furnace having a heater part and an air blast quenching part. In this case, the glass on which the SnO₂: F film 4 has been formed is first heated to 600° C. or above by the heater part, and is then conveyed into the air blast quenching part, where compressed air at room temperature is discharged from a compressor and fed onto the surface of the glass, thus cooling the surface of the glass and hence generating compressive stress, whereupon the glass is strengthened. As a result, strengthened glass having a surface compressive stress of 60 MN/m² or more and a number of fractured glass pieces as stipulated in JIS R3206 of 40 pieces or more can be obtained quickly at low cost.

Moreover, by adjusting the air blast quenching rate of the glass in this method, double-strengthened glass having a surface compressive stress of 20 to 60 MN/m² as stipulated in JIS R3222 can be obtained.

Similarly, in the case of carrying out bending processing, by carrying out heat treatment at 600° C. or above after the SnO₂: F film 4 has been formed, bending processing can be carried out and thus glass having a curved surface can be obtained, without the properties of the SnO₂: F film 4 as a low-radiation layer being deteriorated.

Moreover, in the case of carrying out degassing treatment when, for example, producing a multi-layered glass having therein a reduced pressure layer as a hollow layer, by carrying out heat treatment at 150° C. or above after the SnO₂: F film 4 has been formed, the desired degassing treatment can be carried out without the properties of the SnO₂: F film 4 as a low-radiation layer being deteriorated.

Moreover, freezers and refrigerators in supermarkets, convenience stores and the like are in general often used for storing and displaying foods, and hence from the viewpoint of hygiene it is preferable to carry out antibacterial treatment by applying an antibacterial agent such as a silver colloid dispersion onto the surfaces of the glass substrate 1 and the SnO₂: F film 4, to prevent the proliferation of pathogenic bacteria such as coli bacteria and O157. In this case, however, antibacterial treatment on the SnO₂: F film 4 must be carried out in such a manner as not to impair the low-radiation function of the SnO₂: F film 4.

FIG. 4 is a schematic sectional view of a glass for freezers and refrigerators according to a second embodiment of the present invention.

In the second embodiment, the SnO₂ film 2, the SiO₂ film 3 and the SnO₂: F film 4 are formed in this order on the glass substrate 1 as in the first embodiment described above. A TiO₂ film 11, which is a photocatalytically active layer, is formed on the surface of the SnO₂: F film 4, and an SiO₂ film containing aluminum (Al) (hereinafter referred to as “SiO₂: Al film”) 12 is formed on the surface of the TiO₂ film 11. The TiO₂ film 11 and the SiO₂: Al film 12 together make up a surface layer 13, which has a hydrophilic/moisture-retaining function.

If a surface layer 13 having a hydrophilic/moisture-retaining function is formed on the surface of the SnO₂: F film 4 as described above, then this surface layer 13 will have an action of reducing the contact angle of any water droplets that attach to the surface layer 13, and hence even if moisture condenses onto the surface layer 13, the glass will not be prone to clouding up, and hence impairment of the transparency can be avoided. Moreover, in the present second embodiment, because the surface layer 13 having the hydrophilic/moisture-retaining function as described above contains the TiO₂ film 11, which is a photocatalytically active layer, organic soiling on the surface of the glass for freezers and refrigerators will be decomposed if the inside of the freezer or refrigerator is illuminated with lighting equipment such as fluorescent lighting, and hence the hydrophilic/moisture-retaining function can be maintained over a long time.

The surface layer 13 must be formed in such a way that the high infrared-reflecting performance of the low-radiation layer is not impaired, and hence the surface layer 13 is preferably as thin as possible while considering the balance between the hydrophilic/moisture-retaining function and the low-radiation performance. The total thickness of the surface layer 13 is preferably 0.5 to 1000 nm, more preferably 0.5 to 700 nm, yet more preferably 1 to 500 nm, and most preferably 1 to 300 nm.

The surface layer 13 can be manufactured by a vacuum deposition method, a sputtering method, a CVD method, a spreading application method or the like. To activate the photocatalytic substance, it is effective to carry out heat treatment either during or after the film formation.

A description will now be given of a manner in which the surface layer 13 is manufactured by a sputtering method.

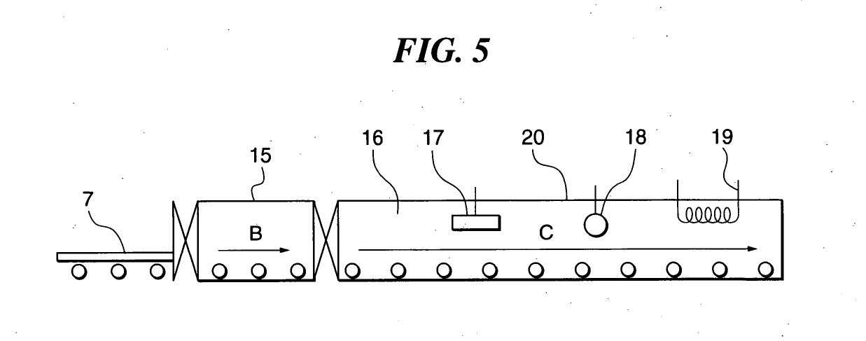

FIG. 5 is a schematic view showing the constitution of a load-lock-type in-line-type magnetron sputtering apparatus for forming the surface layer 13 on the surface of the SnO₂:F film 4 (hereinafter referred to merely as the “sputtering apparatus”). The sputtering apparatus has a load-lock chamber 15 and a film-forming chamber 16. Inside the film-forming chamber 16 are first and second cathodes 17 and 18 and a heater 19.

In the case, for example, of forming a surface layer 13 as shown in FIG. 4, a glass 7 having formed on a surface thereof the film laminate 6 as in the first embodiment is conveyed into the load-lock chamber 15, and evacuation is carried out to reduce the pressure to a predetermined pressure, and then the glass 7 is conveyed into the film-forming chamber 16 as shown by the arrow B in FIG. 5. A sputtering gas is then fed into the film-forming chamber 16 from a gas supply port 20, and at the same time the glass 7 is heated to a predetermined temperature. A predetermined voltage is then applied to the first cathode 17 on which has been set titanium as a target substance. As a result, reactive sputtering between the titanium and oxygen in the sputtering gas is brought about under the predetermined high temperature, and by moving the glass 7 back and forth under the first cathode 17, the TiO₂ film 11 is formed as a fourth layer on the surface of the film laminate 6. Moreover, silicon to which aluminum has been added is set as a target on the second cathode 18, and after the TiO₂ film 11 has been formed, the glass 7 is conveyed in the direction of the arrow C in FIG. 5, and similarly to above the glass 7 is moved back and forth under the second cathode 18, thus forming the SiO₂:Al film 12 as a fifth layer on the surface of the TiO₂ film 11 by reactive sputtering. As a result, a glass for freezers and refrigerators having the surface layer 13 can be produced. The thicknesses of the TiO₂ film 11 and the SiO₂:Al film 12 are controlled by adjusting the number of times that the glass 7 is moved back and forth and the speed of this movement.

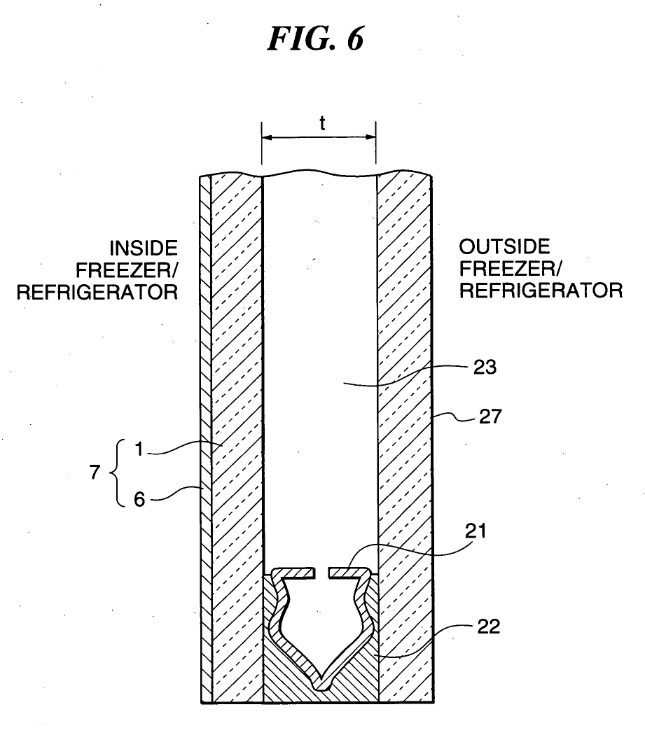

FIG. 6 is a sectional view of essential parts of a multi-layered glass, which is a glass article according to a first embodiment of the present invention, that uses the glass for freezers and refrigerators as described above. In the multi-layered glass, a sheet of the glass 7 for freezers and refrigerators on which the film laminate 6 has been formed, and a sheet of float plate glass 27, which is a single glass plate made of a soda-lime glass or the like, are arranged such that the film laminate 6 is on the outside (when the multi-layered glass is installed in a freezer or refrigerator, this film laminate 6 will be exposed to the air inside the freezer or refrigerator). Spacers 21 that contain a drying agent are interposed between the glass 7 and the float plate glass 27 near to each end of the multi-layered glass, and each end of the multi-layered glass is heat sealed with a sealant 22 such as butyl rubber. As a result, a hollow layer 23 surrounded by the glass 7 for freezers and refrigerators, the float plate glass 27, the spacers 21 and the sealant 22 is formed.

It has been known from hitherto that such a multi-layered glass has an improved thermal insulation performance compared with a single glass plate. However, by using the glass 7 for freezers and refrigerators of the present invention, the occurrence of condensation can be prevented, and moreover the thermal insulation performance can be further improved. Moreover, from the viewpoint of improving the thermal insulation performance, the hollow layer 23 is preferably made to be an air layer or a thermally insulating gas layer filled with argon gas or the like. Also, from the viewpoint of preventing condensation, the hollow layer 23 is preferably maintained in a dry state. To maintain the hollow layer 23 in a dry state and moreover maintain a state of cleanliness, both ends of the multi-layered glass are preferably completely sealed with the sealant 22 as described above. However, the state of sealing may be incomplete, and an apparatus that exchanges the gas in the hollow layer 23 may be attached, provided that there are no adverse effects on the thermal insulation ability or the transparency of the multi-layered glass.

From the viewpoint of securing the desired thermal insulation performance, the spacing t between the glass 7 and the float plate glass 27 (i.e. the thickness of the hollow layer 23) is preferably set to be at least 4 mm.

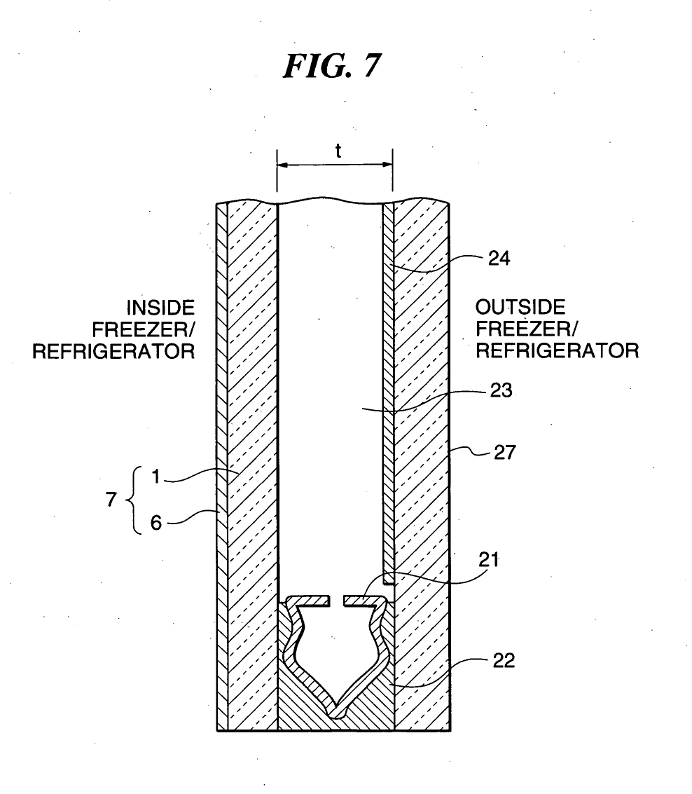

FIG. 7 is a sectional view of essential parts of a multi-layered glass according to a second embodiment of the present invention. In this multi-layered glass, a low-radiation coating is applied onto or a transparent film containing a low-radiation substance is adhered onto a surface of the glass substrate 1 in contact with the hollow layer 23, thus forming a low-radiation layer 24, and hence further improving the thermal insulation.

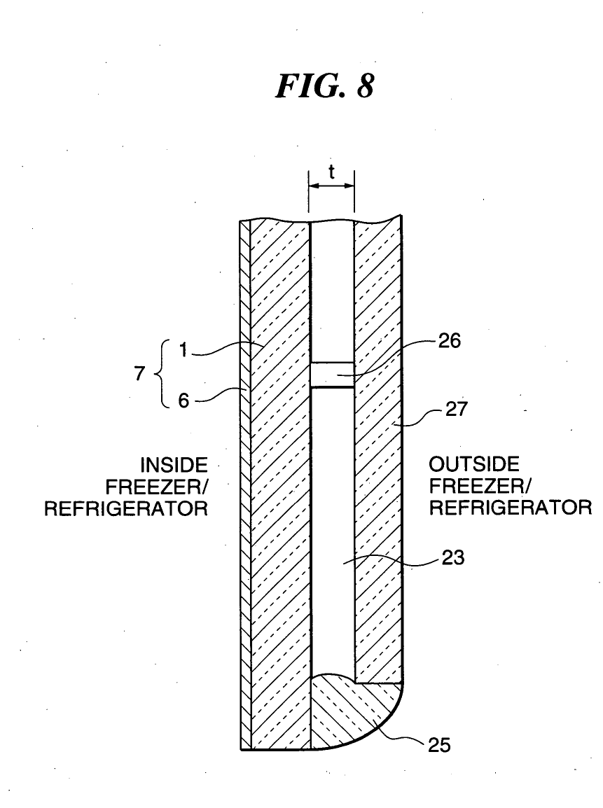

FIG. 8 is a sectional view of main parts of a third embodiment of a multi-layered glass according to a third embodiment of the present invention. In this multi-layered glass, the film laminate 6 is on the outside (when the multi-layered glass is installed in a freezer or refrigerator, this film laminate 6 will be exposed to the air inside the freezer or refrigerator), the spacing t between the glass 7 and the float plate glass 27 (i.e. the thickness of the hollow layer 23) is set to 0.2 to 1 mm and the hollow layer 23 is made to be in a predetermined reduced pressure state, each end of the multi-layered glass is sealed with a low-melting-point glass 25, and small spacers 26 for adjusting the spacing between the glass 7 and the float plate glass 27 are provided in appropriate places in the hollow layer 23.

By making the hollow layer 23 be a reduced pressure layer as described above, effects similar to those described earlier for the case that the hollow layer 23 is an air layer or a thermally insulating gas layer can be produced.

It should be noted that the present invention is not limited to the embodiments described above, but rather can also be similarly applied to laminated glass. That is, in another preferable embodiment, a plurality of sheets of glass including at least one sheet of the glass for freezers and refrigerators of the present invention are bonded together via a transparent resin such as polyvinyl butyral, such that the low-radiation layer side of the glass for freezers and refrigerators of the present invention faces onto the space at a temperature below room temperature. For such a laminated glass, safety is improved in the case that the glass breaks.

Moreover, in other preferable embodiments of the present invention, the multi-layered glass may have two or more hollow layers, or a transparent film (which may contain a low-radiation substance) may be placed in the hollow layer between the two glass surfaces facing one another in a position away from each of the two glass surfaces. It also goes without saying that the present invention can similarly be applied to a glass article in which a multi-layered glass and a laminated glass are combined.

Moreover, the embodiments described above relate to flat glass plates, but the present invention can similarly be applied to glass plates having curved surfaces.

### EXAMPLES

Specific examples of the present invention will now be described.

### First Examples

The present inventors washed and dried a sheet of float plate glass of thickness 3 mm, and taking this sheet of float plate glass as the glass substrate 1, formed a film laminate 6 on the glass substrate 1 using a CVD film-forming apparatus (see FIG. 3). That is, conveying the glass substrate 1 on a mesh belt open to the atmosphere, the glass substrate 1 was heated to a surface temperature of about 650° C. using the heater 9, and then predetermined film-forming raw materials were fed onto the glass substrate 1 from film-forming raw material supply parts 10 while passing the glass substrate 1 under the film-forming raw material supply parts 10, thus causing chemical reactions to occur on the glass substrate 1 and depositing solid phases, thus building up the SnO₂ film 2, the SiO₂ film 3 and the SnO₂: F film 4 on the glass substrate 1 in this order. Thus, test pieces (Examples 1 to 3) were prepared which each have a laminated structure of glass substrate 1/SnO₂ film 2/SiO₂ film 3/SnO₂: F film 4 (see FIG. 1).

Specifically, using monobutyltin trichloride (hereinafter referred to as “MBTC”) as a tin raw material, the MBTC was heated to 150° C. and the resulting MBTC vapor was fed to the first film-forming raw material supply part 10a using nitrogen as a carrier gas such that the MBTC concentration was 0.001 mol per mol of the nitrogen, and at the same time oxygen was fed as an oxidizing gas to the first film-forming raw material supply part 10a from a separate line. A thermal decomposition reaction and an oxidation reaction were thus made to occur on the glass substrate 1, building up an SnO₂ film 2 of thickness 25 nm as a first layer on the glass substrate 1. Next, using monosilane as a silicon raw material, the monosilane gas was fed directly from a gas cylinder to the second film-forming raw material supply part 10b, and, as when forming the SnO₂ film 2, oxygen was fed as an oxidizing gas to the second film-forming raw material supply part 10b from a separate line. A thermal decomposition reaction and an oxidation reaction were thus made to occur on top of the SnO₂ film 2, building up an SiO₂ film 3 of thickness 25 nm as a second layer on top of the SnO₂ film 2. Next, using MTBC as a tin raw material and a trifluoroacetate as a fluorine raw material, these film-forming raw materials were sprayed out from the third to fifth film-forming raw material supply parts 10c to 10e, thus building up an SnO₂: F film 4 of thickness 350 nm as a third layer on top of the SiO₂ film 3. That is, because the SnO₂: F film 4 was thick at 350 nm, the feeding of the film-forming raw materials onto the SiO₂ film 3 was carried out through a plurality of stages. Specifically, the MBTC was heated to about 150° C. and the resulting MBTC vapor was carried using nitrogen as a carrier gas such that the MBTC concentration was 0.01 mol per mol of the nitrogen, at the same time water vapor for promoting the decomposition of the MTBC was carried using nitrogen as a carrier gas such that the concentration of the water vapor was 5 mol per 1 mol of the nitrogen, and the trifluoroacetate was heated to about 150° C. and the resulting trifluoroacetate vapor was carried from a separate line using nitrogen as a carrier gas; the MTBC vapor, the water vapor and the trifluoroacetate vapor were fed to the third to fifth film-forming raw material supply parts 10c to 10e, and in addition oxygen was fed as an oxidizing gas to the third to fifth film-forming raw material supply parts 10c to 10e from a separate line. The MTBC vapor, the trifluoroacetate vapor, the water vapor and the oxygen were then fed onto the SiO₂ film 3, whereby a thermal decomposition reaction and an oxidation reaction were made to occur, thus building up the SnO₂: F film 4 as the third layer on top of the SiO₂ film 3 (Example 1).

The present inventors prepared glasses for freezers and refrigerators, which are different only in the thickness of the SnO₂: F film 4 from the test piece of Example 1.

Specifically, after sequentially forming the SnO₂ film 2 and the SiO₂ film 3 on the glass substrate 1 in the same manner as described above, the MTBC vapor, the trifluoroacetate vapor, the water vapor and the oxygen were then fed from the third film-forming raw material supply part 10c onto the SiO₂ film 3, whereby a thermal decomposition reaction and an oxidation reaction were made to occur, thus building up the SnO₂: F film 4 with a thickness of 120 nm as the third layer on top of the SiO₂ film 3 (Example 2).

Similarly, after sequentially forming the SnO₂ film 2 and the SiO₂ film 3 on the glass substrate 1 in the same manner as described above, the MTBC vapor, the trifluoroacetate vapor, the water vapor and the oxygen were then fed from the third and fourth film-forming raw material supply parts 10c and 10d onto the SiO₂ film 3, whereby a thermal decomposition reaction and an oxidation reaction were made to occur, thus building up the SnO₂: F film 4 with a thickness of 240 nm as the third layer on top of the SiO₂ film 3 (Example 3)

Then, the present inventors installed each of the above test pieces (Examples 1 to 3) as a glass window of a freely opening/closing vertical door in a freezer with the SnO₂: F film 4 facing the inside of the freezer, and then measured the surface temperature on the SnO₂: F film 4 side (hereinafter referred to as the “inside freezer surface temperature”) and the surface temperature on the glass substrate 1 side (hereinafter referred to as the “outside freezer surface temperature”) under conditions of a temperature inside the freezer of −20° C. and a temperature outside the freezer of 20° C., and also measured the heat transmission coefficient, which is an indicator of the thermal insulation performance, in accordance with JIS A4710. Note that an air current agitating apparatus was not used either in the heating cabinet on the thermostatic chamber side or on the low temperature chamber side, but rather natural convection was allowed to occur.

Moreover, as Comparative Example 1, the present inventors installed a single sheet of float plate glass in a freezer, and as Comparative Example 2, installed the test piece of Example 1 in a freezer but with the SnO₂: F film 4 facing the outside of the freezer; the inside freezer surface temperature, the outside freezer surface temperature and the heat transmission coefficient were measured under conditions of a temperature inside the freezer of —20° C. and a temperature outside the freezer of 20° C. as above.

It should be noted that the surface temperatures were measured using the infrared radiation temperature corrected with the emissivity of the glass surface and the low-radiation layer.

Moreover, because it is considered necessary for the glass for freezers and refrigerators to have an excellent transparency, the visible light transmittance was measured in accordance with JIS R3106. Furthermore, the normal emittance, which is an indicator of the low-radiation performance, was also measured in accordance with JIS R3106.

The measurement results for Examples and Comparative Examples are shown in Table 1.

TABLE 1

| | | | | | Inside Freezer | Outside Freezer | Heat | | Surface Temperature |
|---|---|---|---|---|---|---|---|---|---|
| | | | | Film | Surface | Surface | Transmission | Visible Light | of Inside Freezer |
| | | | Film | Thickness | Temperature | Temperature | Coefficient | Transmittance | Normal Emittance |
| | | | Type | (nm) | (° C.) | (° C.) | (W/m² · K) | (%) | (−) |
| Example | 1 | Layer 1 | SnO₂ | 25 | 3.8 | 4.3 | 3.7 | 83.0 | 0.13 |
| | | Layer 2 | SiO₂ | 25 | | | | | |
| | | Layer 3 | SnO₂:F | 350 | | | | | |
| | 2 | Layer 1 | SnO₂ | 25 | 2.6 | 3.3 | 4.0 | 87.0 | 0.34 |
| | | Layer 2 | SiO₂ | 25 | | | | | |
| | | Layer 3 | SnO₂:F | 120 | | | | | |
| | 3 | Layer 1 | SnO₂ | 25 | 3.4 | 4.0 | 3.8 | 83.5 | 0.19 |
| | | Layer 2 | SiO₂ | 25 | | | | | |
| | | Layer 3 | SnO₂:F | 240 | | | | | |
| Comparative | 1 | | — | — | 0.5 | 1.1 | 4.6 | 90.1 | 0.90 |
| Example | 2 | Layer 1 | SnO₂ | 25 | −3.2 | −2.7 | 3.6 | 83.0 | 0.90 |
| | * | Layer 2 | SiO₂ | 25 | | | | | |
| | | Layer 3 | SnO₂:F | 350 | | | | | |

* In Comparative Example 2, measurement was made with the film-formed surface facing the outside of the freezer.

As is clear from Table 1, in Comparative Example 1, which was just a single sheet of float plate glass, the inside freezer surface temperature and the outside freezer surface temperature were low at 0.50° C. and 1.1° C. respectively, and moreover, because no low-radiation layer was formed, the heat transmission coefficient was high at 4.6 W/m²·K. In Comparative Example 2, a low-radiation layer (SnO₂:F film 4) was formed, and hence the heat transmission coefficient was low at 3.6 W/M²·K and thus the thermal insulation ability was satisfactory. However, the inside freezer surface temperature and the outside freezer surface temperature were low at −3.20° C. and −2.70° C. respectively and thus surface condensation was prone to occur.

In contrast with the above, in Examples 1 to 3, the inside freezer surface temperature and the outside freezer surface temperature were high at 2.6 to 3.80° C. and 3.3 to 4.30° C. respectively compared with Comparative Examples 1 and 2. It was thus verified that it was possible to make clouding up of the window glass not prone to occur, and hence that it was possible to avoid impairment of the ability to see into the freezer from the outside. Moreover, the heat transmission coefficient was 3.7 to 4.0 W/m²·K and hence it was possible to secure the desired thermal insulation performance.

Moreover, in Examples 1 to 3, the visible light transmittance was not less than 80%, and hence it was possible to secure sufficient transparency. Furthermore, the normal emittance was not more than 0.35, and hence it can be seen that radiative heat exchange between the surface of the glass and the inside of the freezer was suppressed, and thus the emissivity for radiant heat was reduced, contributing to an increase in the surface temperature of the glass inside the freezer.

Moreover, it is desirable for the reflected color tone to be a neutral system, and hence for Example 1, the reflectance spectrum from the thin film surface side was measured in accordance with JIS R3106, the chromaticness indices a* and b* were calculated in accordance with JIS Z8729, and the reflected color tone was evaluated. The results were that the chromaticness indices a* and b* were −1.5 and −1.0 respectively, which are within the ranges |a*|≦5 and |b*|≦5, thus verifying that the glass had a neutral reflected color tone.

Note also that it can be seen from Table 1 that, with regard to Examples 1 to 3, the thicker the SnO₂: F film 4, the lower the emissivity for radiant heat can be made, and hence the more effectively condensation is prevented.

### Second Example

Next, using a test piece having the same film structure as in Example 1 described above, the present inventors carried out heat treatment, thus preparing a strengthened glass.

Specifically, to strengthen the convective heating, the upper part air inflow amount at the heater part in the thermal strengthening furnace was adjusted, the test piece was heated at a heating temperature of 640° C., and then compressed air at room temperature was fed onto the test piece in the air blast quenching part from a compressor, thus preparing a good strengthened glass having a surface compressive stress of 80 MN/m² and no visible warping.

There are no stipulations on strengthened glass in JIS R3206 regarding a glass plate of thickness 3 mm, but in the present example the number of fractured glass pieces as determined by the method stipulated in JIS R3206 was at least 40 pieces, and hence it was judged that the glass had the characteristics of a strengthened glass.

The visible light transmittance and the normal emittance of the strengthened glass were measured to be 83% and 0.13 respectively, and thus had not changed compared with before the heat treatment

That is, it was verified that even when heat treatment was carried out on the glass for freezers and refrigerators of the present invention, there was no impairment of performance whatsoever, i.e. it was possible to obtain a strengthened glass having excellent thermal insulation performance and no impairment of transparency.

Note that the measuring equipment used for calculating the visible light transmittance and the normal emittance were the same as in First Examples.

### Third Example

Next, using a test piece having the same film structure as in Example 1 described above, the present inventors carried out antibacterial treatment.

Specifically, the antibacterial treatment was carried out by heating the test piece to approximately 300° C., and then spraying a silver colloid dispersion (concentration 0.1%) onto both surfaces of the test piece.

The test piece of the present Third Example on which the antibacterial treatment had been carried out as described above was subjected to the film adherence method in Antibacterial Activity Test Methods I (published in 1998) advocated by the Society of Industrial Technology for Antimicrobial Articles, with the dripping amount changed to 0.1 ml with “no” film facing the glass, whereupon it was found that both surfaces of the test piece had an antibacterial property.

Moreover, the visible light transmittance and the normal emittance of the test piece of the present Third Example were measured to be 83% and 0.13 respectively, and with regard to the reflected color tone, the chromaticness indices a* and b* were −1.5 and −1.0 respectively. The visible light transmittance, the normal emittance and the reflected color tone were thus unchanged compared with before the antibacterial treatment.

Note that the measuring equipment used for calculating the visible light transmittance, the normal emittance and the reflected color tone were the same as in First Examples.

Next, the present inventors installed the test piece of Third Example as a glass window of a freely opening/closing vertical door in a freezer with the SiO₂: F film 4 facing the inside of the freezer, and then measured the inside freezer surface temperature, the outside freezer surface temperature and the heat transmission coefficient under conditions of a temperature inside the freezer of −5° C. and a temperature outside the freezer of 20° C. The inside freezer surface temperature, the outside freezer surface temperature and the heat transmission coefficient were 10.1° C., 10.40° C. and 3.4 W/m²·K respectively, and hence the thermal insulation performance was sufficient. Moreover, it was found that the occurrence of condensation on the surfaces of the glass inside and outside the freezer, which causes a worsening of the transparency, was prevented.

Note that the measurements of the inside freezer surface temperature, the outside freezer surface temperature and the heat transmission coefficient were carried out using the same measuring equipment as in First Examples.

### Fourth Example

Next, the present inventors installed the glass of the present invention and a sheet of float plate glass as glass for an up/down door on the upper surface of a freezer main body 8 as shown in (b) of FIG. 2 at an inclination of 20° (=θ) relative to the horizontal direction, to determine the transparency.

That is, a test piece having the same film structure as in Example 1 was used as one up/down door glass, and a single sheet of float plate glass was used as the other up/down door glass. The test piece was installed in the freezer main body 8 with the SnO₂: F film 4 facing the inside of the freezer.

An up/down door opening/closing test was then carried out in which the temperature inside the freezer and the temperature outside the freezer were set to −30° C. and 20° C. respectively and products were put into the freezer. It was found as a result that when the up/down door was opened and closed, the float plate glass clouded up and the ability to visually identify the products inside the freezer worsened. In contrast, the test piece of the present invention only clouded up very slightly, and hence the ability to visually identify the products inside the freezer was not affected, i.e. the transparency was not impaired.

### Fifth Examples

Next, using a sputtering apparatus (see FIG. 5), the present inventors built up a surface layer 13 comprised of a TiO₂ film 11 and a SiO₂:Al film 12 on a test piece having the same film structure as in Example 1, thus preparing a test piece (Example 11) having a film structure of glass substrate 1/SnO₂ film 2/SiO₂ film 3/SnO₂:F film 4/TiO₂ film 11/SiO₂:Al film 12 (see FIG. 4).

Specifically, a glass 7 having the same film structure as in Example 1 was washed and conveyed into the load-lock chamber 15 of the sputtering apparatus, the load-lock chamber 15 was evacuated to reduce the pressure to a predetermined pressure, and then the glass 7 was conveyed into the film-forming chamber 16 as shown by the arrow B in FIG. 5. Oxygen was then fed in from the gas supply port 20 until the pressure in the film-forming chamber 16 became 0.3 Pa, and at the same time the glass 7 was heated to approximately 350° C. by the heater 19. A DC voltage of 440 V was then applied to the first cathode 17 on which titanium had been set as a target substance. As a result, reactive sputtering between the titanium and the oxygen in the sputtering gas was brought about, and by moving the glass 7 back and forth under the first cathode 17, a TiO₂ film 11 of thickness 250 nm was built up as a fourth layer on the surface of the SnO₂: F film 4. Next, the power supply to the heater 19 was switched off, and using the second cathode 18 on which silicon with 10 wt % of aluminum added thereto had been set as a target, reactive sputtering was brought about as above while moving the test piece back and forth under the second cathode 18, thus building up an SiO₂: Al film 12 of thickness 10 nm as a fifth layer (Example 11).

The normal emittance was measured for the glass thus obtained using the same methods as in First Examples, and in addition the water droplet contact angle was measured and a photocatalytic activity test was carried out.

As a result, the normal emittance was 0.13 as for Example 1, and hence no degradation in properties due to the formation of the surface layer 13 was found. Moreover, the water droplet contact angle was found to be low at 5°. Furthermore, the photocatalytic activity test was carried out by applying triolein onto the surface of the surface layer 13 and irradiating with ultraviolet rays; satisfactory results were obtained.

Moreover, the present inventors verified the transparency of the present test piece (Example 11) when used as a glass window of a double sliding door installed in the vertical direction in a freezer.

Specifically, the test piece of Example 11 was used as one of the glass windows of the double sliding door, and a sheet of float plate glass was used as a comparative example (Comparative Example 11) as the other glass window. The test piece was installed in the freezer main body with the surface layer 13 facing the inside of the freezer.

A door opening/closing test was then carried out by setting the temperature in the freezer to −20° C. and the temperature of the air outside the freezer to 20° C., illuminating the inside of the freezer every day with fluorescent lighting from 9 am to 8 pm, and opening and closing the door periodically for 30 days.

The measurement results for Example 11 and Comparative Example 11 are shown in Table 2.

TABLE 2

| | | | | Film | Door |
|---|---|---|---|---|---|
| | | | | Thickness | Opening/Closing |
| | | | Film Type | (nm) | Test |
| Example | 11 | Layer 1 | SnO₂ | 25 | ◯ |
| | | Layer 2 | SiO₂ | 25 | |
| | | Layer 3 | SnO₂:F | 350 | |
| | | Layer 4 | TiO₂ | 250 | |
| | | Layer 5 | SiO₂:Al | 10 | |

| | | | | |
|---|---|---|---|---|
| Comparative | 11 | — | — | X |
| Example | | | | |

As can be seen from Table 2, the results of the door opening/closing test were poor for the single piece of float plate glass in that the float plate glass clouded up upon opening and closing the door and hence there was a drop in transparency, whereas satisfactory results were obtained for Example 11 in that no clouding up occurred at all over the test period (30 days).

It was thus verified that even if the inside of the freezer is illuminated with fluorescent lighting, organic soiling on the surface of the glass of the present invention is decomposed and hence the hydrophilic/moisture-retaining function can be maintained over a long time.

### Sixth Examples

Next, the present inventors manufactured three different types of multi-layered glass using the test piece of Example 1 (Examples 21 to 23).

Specifically, using the test piece of Example 1 (a sheet of the glass 7 of the present invention, hereinafter referred to as the “glass of the present invention”), and a sheet of float plate glass 27 made of a soda-lime glass, a multi-layered glass was manufactured in which the glass 7 of the present invention and the float plate glass 27 were arranged in facing relation to one another with the surface of the glass 7 of the present invention on which the film laminate 6 was formed positioned on the outside of the multi-layered glass, and in which the hollow layer 23 formed between the glass 7 of the present invention and the float plate glass 27 was filled with air, as shown in FIG. 6. The spacing t between the glass 7 of the present invention and the float plate glass 27 (i.e. the thickness of the hollow layer 23) was adjusted to 12 mm using aluminum spacers 21 (Example 21).

Next, using a sheet of the glass 7 of the present invention and a sheet of the float plate glass 27 as described above, a multi-layered glass in which the hollow layer 23 was filled with argon gas as a thermally insulating gas was manufactured. The filling with the argon gas was carried out by forming two holes passing through the aluminum spacers 21, and feeding argon gas into the hollow layer 23 from one of the holes for one hour to replace the air in the hollow layer 23 with argon gas, before sealing up the two holes with a sealant. Moreover, the spacing t between the glass 7 of the present invention and the float plate glass 27 (i.e. the thickness of the hollow layer 23) was adjusted to 6mm using the spacers 21 (Example 22).

Next, using a sheet of the glass 7 of the present invention and a sheet of the float plate glass 27, the glass 7 of the present invention and the float plate glass 27 were arranged in facing relation to one another with the surface of the glass 7 of the present invention on which the film laminate 6 was formed positioned on the outside, small spacers 26 made of metal were interposed between the glass 7 of the present invention and the float plate glass 27 to adjust the spacing t between the glass 7 of the present invention and the float plate glass 27 (i.e. the thickness of the hollow layer 23) to 0.2 mm, and the top and bottom ends were sealed with a low-melting-point glass 25, as shown in FIG. 8. Specifically, a small hole was formed in the float plate glass 27, heating was carried out to approximately 350° C. and the low-melting-point glass 25 was fused on, and then the glass 7 of the present invention and the float plate glass 27 were heated to approximately 250° C., the hollow layer 23 was put into a reduced pressure state, and then sealing was completed, thus making the hollow layer 23 into a reduced pressure layer. The pressure in the reduced pressure layer was not more than 1 Pa (Example 23).

Next, the present inventors measured the visible light transmittance of the test piece of each of the examples described above, and then each of the test pieces was installed as a glass window of a freely opening/closing vertical door in a freezer with the glass 7 of the present invention facing the inside of the freezer, and the inside freezer surface temperature, the outside freezer surface temperature and the heat transmission coefficient were measured under conditions of a temperature inside the freezer of −20° C. and a temperature outside the freezer of 20° C.

Moreover, comparative examples were also prepared as described above but using two sheets of the float plate glass instead of one sheet of the float plate glass and one sheet of the glass of the present invention; the hollow layer 23 was made to be an air layer (Comparative Example 21), an argon gas layer (Comparative Example 22) or a reduced pressure layer (Comparative Example 23) as described above. Each of Comparative Examples 21 to 23 was installed as a glass window of a vertical door in a freezer as above, and measurements were carried out as for Examples 21 to 23. Note that the measurements were carried out using the same equipment as in First Examples.

The measurement results for the examples and comparative examples are shown in Table 3.

TABLE 3

| | | Inside | Outside | | Visible |
|---|---|---|---|---|---|
| | | Freezer | Freezer | Heat | Light |
| | | Surface | Surface | Transmission | Trans- |
| | | Temperature | Temperature | Coefficient | mittance |
| | | (° C.) | (° C.) | (W/m² · K) | (%) |
| Example | 21 | −5.0 | 10.7 | 2.1 | 75.4 |
| | 22 | −4.6 | 10.2 | 2.2 | 75.4 |
| | 23 | −5.6 | 11.0 | 2.0 | 75.4 |
| Comparative | 21 | −8.2 | 9.7 | 2.3 | 81.8 |
| Example | 22 | −7.6 | 9.1 | 2.5 | 81.8 |
| | 23 | −8.8 | 10.0 | 2.2 | 81.8 |

As can be seen from Table 3, for all of Comparative Examples 21 to 23, the visible light transmittance was more than 80%, and the heat transmission coefficient was not more than 2.5 W/m²_K and hence the thermal insulation performance was excellent. However, because a low-radiation layer was not formed, the glass surface temperatures inside and outside the freezer were low, and hence the glass was prone to clouding up and thus the transparency was impaired.

In contrast, for Examples 21 to 23, because a low-radiation layer was formed, compared with Comparative Examples 21 to 23, the thermal insulation performance was better, and moreover the glass surface temperatures inside and outside the freezer were higher, and thus it was found that it was possible to considerably avoid impairment of the transparency.

### Industrial Applicability

The glass for-freezers and refrigerators according to the present invention can be used in a freezing/refrigerating showcase used in shops such as supermarkets and convenience stores or a so-called see-through type vending machine that allows consumers to determine the state of availability of products instantaneously, as glass windows which are required to have transparency while securing thermal insulation.

1. A glass for freezers and refrigerators, which partitions a first space at room temperature from a second space at a temperature below the room temperature, comprising a first low-radiation layer comprising an oxide semiconductor film formed on a surface of a plate of the glass facing the second space, wherein said low-radiation layer has a normal emittance of not more than 0.19.

2. A glass for freezers and refrigerators as claimed in claim 1, wherein the oxide semiconductor film comprises a tin oxide film containing fluorine.

3. A glass for freezers and refrigerators as claimed in claim 1, further comprising an intermediate layer comprising an inorganic material interposed between the plate of the glass and said low-radiation layer.

4. A glass for freezers and refrigerators as claimed in claim 1, wherein a predetermined heat treatment is carried out at a predetermined temperature on the glass after formation of said low-radiation layer, whereby the glass has improved strength.

5. A glass for freezers and refrigerators as claimed in claim 1, further comprising a surface layer formed on a surface of said low-radiation layer, said surface layer being primarily composed of a composite oxide or a mixed oxide containing at least one element selected from the group consisting of silicon, aluminum and titanium.

6. A glass for freezers and refrigerators as claimed in claim 5, wherein said surface layer has a thickness in a range of 0.5 to 1000 nm.

7. A glass for freezers and refrigerators as claimed in claim 5, wherein said surface layer contains a photocatalytically active substance.

8. A glans for freezers and refrigerators as claimed in claim 1, wherein a predetermined antibacterial treatment is carried out on at least one of a surface of the glass facing the first space and another surface of the glass facing the second space.

9. A glass for freezers and refrigerators as claimed in claim 1, wherein the glass has a visible light transmittance of not less than 60%.

10. A glass for freezers and refrigerators as claimed in claim 1, wherein the glass has a visible light transmittance of not less than 70%.

11. A glass for freezers and refrigerators as claimed in claim 1, wherein the glass has a visible light transmittance of not less than 80%.

12. (canceled)

13. (canceled)

14. A glass for freezers and refrigerators as claimed in claim 1, wherein said low-radiation layer has a normal emittance of not more than 0.15.

15. A glass for freezers and refrigerators as claimed in claim 1, wherein the glass is installed in a freezer or refrigerator main body such that an angle of inclination of the glass relative to a state in which surfaces of the glass are horizontal and said low-radiation layer is on an underside of the glass in a vertical direction is in a range of 0 to 135°.

16. A glass for freezers and refrigerators as claimed in claim 15, wherein the angle of inclination of the glass is in a range of 0 to 60°.

17. A glass article comprising a plurality of sheets of glass including at least one sheet of a glass for freezers and refrigerators as claimed in claim 1, said plurality of sheets of glass being arranged in a facing relation to one another such that a side of the glass for freezers and refrigerators on which said low-radiation layer is formed faces the space at a temperature below room temperature, and at least one hollow layer is formed between said plurality of sheets of glass.

18. A glass article as claimed in claim 17, wherein said hollow layer is selected from the group consisting of an air layer, a thermally insulating gas layer and a reduced pressure layer.

19. A glass article as claimed in claim 17, further comprising a second low-radiation layer or a transparent film containing a low-radiation substance formed on a surface facing said hollow layer of at least one sheet of glass out of said plurality of sheets of glass that face one another.

20. A glass article as claimed in claim 17, wherein said plurality of sheets of glass includes pairs of adjacent sheets of glass, each pair of adjacent sheets of glass having two surfaces facing one another; and the glass article comprises a second low-radiation layer or a transparent film containing a low-radiation substance disposed in said hollow layer in a position away from each of the two surfaces of each pair of adjacent sheets of glass.

21. A glass article comprising a plurality of sheets of glass including at least one sheet of a glass for freezers and refrigerators as claimed in claim 1, and at least one transparent resin layer, said plurality of sheets of glass including at least one sheet of a glass for freezers and refrigerators being superimposed via said at least one transparent resin layer such that a side of the glass for freezers and refrigerators on which said low-radiation layer is formed faces the space at a temperature below the room temperature.

22. A glass article comprising two glass articles as claimed in claim 17, and a transparent resin layer, said two glass articles being superimposed via said transparent resin layer.

23. A glass article as claimed in claim 17, wherein a predetermined antibacterial treatment is carried out on at least one of a surface of the glass facing the first space and another surface of the glass facing the second space.

24. A glass article as claimed in claim 17, wherein said low-radiation layer has a normal emittance of not more than 0.15.

25. The glass article as claimed in claim 24, further comprising a surface layer formed on a surface of said low-radiation layer, and wherein said surface layer has a thickness of 1 to 300 nm.
